(19) United States
(12) Patent Application Publication
(10) Pub. No.: US 2022/0121792 A1
(43) Pub. Date: Apr. 21, 2022

(54) METHOD FOR VALIDATING SIMULATION MODELS

(71) Applicant: Robert Bosch GmbH, Stuttgart (DE)

(72) Inventor: Julian Schmidt, Tuebingen (DE)

(21) Appl. No.: 17/450,567

(22) Filed: Oct. 12, 2021

(30) Foreign Application Priority Data
Oct. 20, 2020 (DE) 102020213199.6

(51) Int. Cl. G06F 30/20; G06F 17/18; G06F 17/16

(52) U.S. Cl. CPC G06F 30/20; G06F 2111/10; G06F 17/16; G06F 17/18

(57) ABSTRACT

A computer-implemented method for validating simulation data of a simulation model of a technical system. The method includes the following steps: providing simulation data including a number of simulation signals and providing reference data including a number of reference signals, the simulation signals and the reference signals being multidimensional signals, at least two-dimensional signals, and determining a metric between a first probability distribution including the simulation data and a second probability distribution including the reference data by using the 1 Wasserstein metric.

### CROSS REFERENCE

The present application claims the benefit under 35 U.S.C. § 119 of German Patent Application No. DE 102020213199.6 filed on Oct. 20, 2020, which is expressly incorporated herein by reference in its entirety.

### FIELD

The present invention relates to a computer-implemented method for validating simulation data of a simulation model of a technical system.

Further specific embodiments of the present invention relate to a computer program for carrying out the method.

Further specific embodiments of the present invention relate to the utilization of the computer-implemented method and/or of the computer program for validating a simulation model of a technical system, in particular software, hardware, or an embedded system, in particular during the development of the technical system.

### BACKGROUND INFORMATION

Usually reference data are collected at specific points in the parameter space of the simulation model—the so-called validation points—for the purpose of validating a simulation model. These reference data usually derive from real validation experiments or from simulation runs of a highly precise reference model. A so-called model error, a real scalar variable indicating the deviation between the simulation model and the reference, is computed at the validation points.

For validating scalar signals, a validation framework is described for example, which is based on the so-called area validation metric, for example described in Oberkampf, William L. and Christopher J. Roy, “Verification and validation in scientific computing,” Cambridge University Press, 2010. The simulation results and the reference measurements, which ideally involve real experiments, are usually understood as drawings from two different random distributions. This means that an (empirical) cumulative distribution function (CDF) is created from the data for the simulation and for the reference. These cumulative distribution functions are then compared to one another with the aid of a metric, for example the area validation metric, for distribution functions. In the case of the area validation metric, the area between the two distribution functions is used as a measure for the discrepancy between the two distributions.

The conventional area validation metric, however, is stretched to its limits even in the rather simple case, in which the received signals are points in the plane. In the conventional validation framework, there is no possibility of statistically comparing the simulation and the reference. If several data points, in the best case a plurality of data points, were received for the simulation and the reference in each case, it has not been possible until now to compare the two data sets as a whole to one another and to compute an objective value of the discrepancy.

It is furthermore not possible to readily expand the conventional area validation metric to include multidimensional signals. The expansion to a hypervolume validation metric is not readily possible, since the volume that is enclosed by two measurements is already infinitely large. Furthermore, if individual metric results are simply added to one another, the correlations between two signals are not taken into consideration at all. This is a problem in particular in the case of highly correlated outputs, such as the individual points in time of a time series.

An object of the present invention is thus to overcome the disadvantages from the related art.

### SUMMARY

One specific embodiment of the present invention relates to a computer-implemented method for validating simulation data of a simulation model of a technical system;

the example method including the following steps:
providing simulation data including a number of simulation signals and providing reference data including a number of reference signals, the simulation signals and the reference signals being multidimensional signals, at least two-dimensional signals,
and determining a metric between a first probability distribution including the simulation data and a second probability distribution including the reference data by using the 1 Wasserstein metric.

The 1 Wasserstein metric is a metric in the mathematical sense in the space of probability distributions. The 1 Wasserstein metric expands the conventional method of the area validation metric to include multidimensional signals. The advantageous properties of the area validation metric advantageously keep their validity analogously for higher dimensions. These properties include the following properties in particular: The specific metric, the metric result, has the same unity as the contemplated simulation signals and reference signals. For two individual signals, i.e., one simulation signal and one reference signal, the metric result of the 1 Wasserstein metric is the distance between the two signals. In this case, the 1 Wasserstein metric and the area validation metric provide the same result. If one of the two data groups, for example the reference data, includes only one reference signal, the 1 Wasserstein metric is computed as the arithmetic mean value of the distances of the simulation signals to the reference signal.

According to one specific embodiment of the present invention, the method further includes establishing a cost matrix based on the simulation signals and the reference signals, deriving an optimal transport plan based on the cost matrix, and computing the costs of the optimal transport plan by using the 1 Wasserstein metric.

According to one specific embodiment of the present invention, it is provided that establishing the cost matrix includes computing the distance of a particular simulation signal to a particular reference signal.

According to one specific embodiment of the present invention, it is provided that for computing the distance of a particular simulation signal to a particular reference signal, the Euclidian distance is used as the distance measure. However, other distance measures are also conceivable.

According to one specific embodiment of the present invention, it is provided that the method includes a step of standardizing simulation data and/or reference data. This step is in particular advantageous when the simulation data and/or reference data include signals having different scalings.

According to one specific embodiment of the present invention, it is provided that the multidimensional signals include two- or multidimensional vectors and/or correlated signals and/or time series signals. Two- or multidimensional vectors are used, for example, when a spatial orientation is described. Correlated signals are used, for example, to combine multiple outputs of a model for the purpose of illustrating the correlation of the outputs. In the case of time series signals, each point in time, at which a signal is received, is regarded as an individual signal. A reception of a time series having N points in time is thus illustrated as an N-dimensional signal.

Further specific embodiments of the present invention relate to a computer program for validating data of a simulation model, the computer program including computer-readable instructions, which, if carried out on the computer, prompt the computer to carry out a computer-implemented method according to the specific embodiments.

Further specific embodiments of the present invention relate to a utilization of a computer-implemented method according to the specific embodiments and/or of a computer program according to the specific embodiments for validating a simulation model of a technical system, in particular software, hardware, or an embedded system, in particular during the development of the technical system.

The simulation model is, for example, a HiL, hardware in the loop, or a SiL, software in the loop, simulation model. The simulation model is used in this case to imitate the real environment of the technical system. HiL and SiL are methods for testing hardware and embedded systems or software, for example for support during the development as well as premature start-up. By using the method for validating a simulation model of a technical system, in particular software, hardware, or an embedded system, in particular during the development of the technical system, a simulation-based approval may be supported, for example.

The technical system is software, hardware or an embedded system, for example. The technical system is in particular a technical system, for example a control unit or a software for a control unit, for a motor vehicle, in particular for an autonomous or semi-autonomous motor vehicle. In particular in the automotive area, simulation models often include multidimensional signals.

Other features, possible applications, and advantages of the present invention are derived from the following description of exemplary embodiments of the present invention, which are illustrated in the figures. All features described or illustrated represent the subject matter of the present invention alone or in any arbitrary combination, regardless of their wording in the description or illustration in the figures.

### BRIEF DESCRIPTION OF THE DRAWINGS

FIG. 1 shows aspects of a computer-implemented method in a schematic representation, in accordance with an example embodiment of the present invention.

FIG. 2 shows aspects of a utilization of the computer-implemented method from FIG. 1 in a schematic representation.

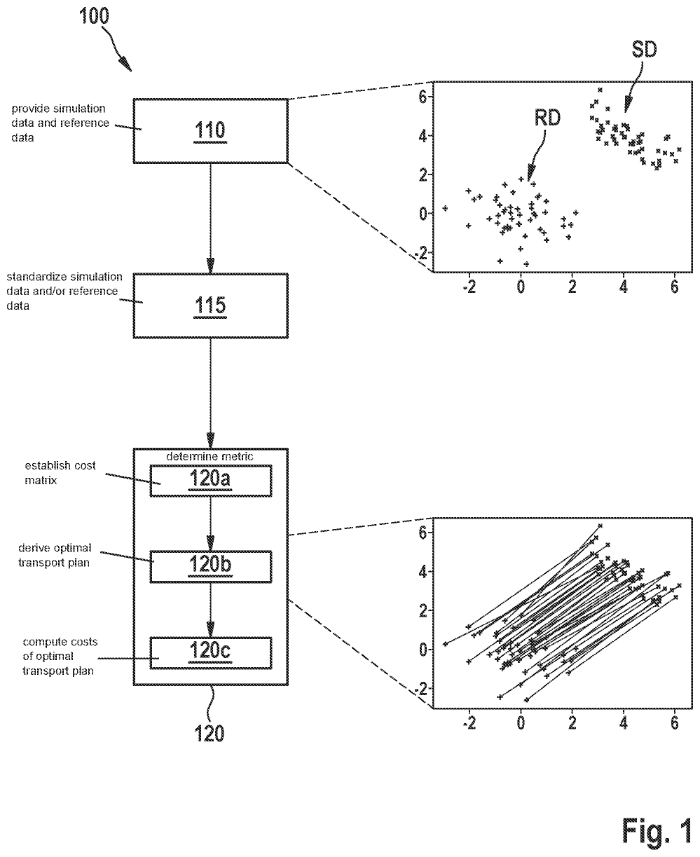

In FIG. 1, the steps of a computer-implemented method 100 for validating simulation data of a simulation model of a technical system are schematically illustrated, in accordance with an example embodiment of the present invention.

### DETAILED DESCRIPTION OF EXAMPLE EMBODIMENTS

Method 100 includes a step 110 for providing simulation data SD including a number of simulation signals and for providing reference data RD including a number of reference signals. The simulation signals and the reference signals are multidimensional, at least two-dimensional, signals.

According to the illustrated specific embodiment of the present invention, simulation data SD include a number n of simulation signals with n>1 and reference data RD include a number m of reference signals with m>1.

In the case that signals having different scalings are to be combined, it is advantageous if a suitable standardization is carried out. In this case, method 100 includes a step 115 for standardizing simulation data SD and/or reference data RD.

Method 100 further includes a step 120 for determining a metric between a first probability distribution including simulation data SD and a second probability distribution including reference data RD by using the 1 Wasserstein metric. The 1 Wasserstein metric is a metric in the mathematical sense in the space of probability distributions.

Determining 120 a metric between a first probability distribution including simulation data SD and a second probability distribution including reference data RD by using the 1 Wasserstein metric includes the following steps:

a step 120 of establishing 120a a cost matrix based on the simulation signals and the reference signals, a step 120b of deriving an optimal transport plan based on the cost matrix, and a step 120c of computing the costs of the optimal transport plan by using the 1 Wasserstein metric.

The cost matrix is a m×n or n×m matrix according to the illustrated specific embodiment. Establishing 120a the cost matrix includes computing the distance of a particular simulation signal to a particular reference signal. In this case, each simulation signal is compared to each reference signal. The i-j-th entry of the matrix is the distance of the i-th simulation signal to the j-th reference signal with 1≤i≤n and 1≤j≤m. For computing the distance, the Euclidian distance is used as the distance measure, for example.

Deriving 120b the optimal transport plan based on the cost matrix takes place, for example, by using a solution algorithm based on the so-called “Hungarian method.” In the case of empirical data, the transport plan is also a matrix of the same dimension as the cost matrix.

Computing 120c the costs of the optimal transport plan takes place by using the 1 Wasserstein metric. The costs of the optimal transport plan is the sought 1 Wasserstein distance between the first probability distribution including simulation data SD and the second probability distribution including reference data RD.

Algorithms for deriving 120c the optimal transport plan and for computing 120c the costs of the optimal transport plan are for example described in:

https://pythonot.github.io/auto_examples/plot_OT_2D samples.html #sphx-glrauto-examples-plot-ot-2d-samples-py.

Method 100 expands the area validation metric to include multidimensional signals by using the 1 Wasserstein metric. In this way, simulation models having multidimensional signals may be validated on the one hand and statistic variances may be incorporated into the validation process on the other hand.

Further specific embodiments relate to the utilization of method 100 for validating a simulation model of a technical system, in particular software, hardware, or an embedded system, in particular during the development of the technical system.

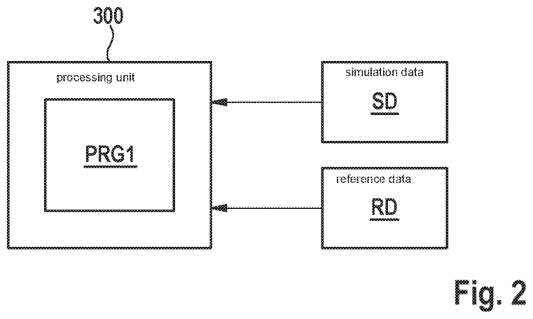

FIG. 2 shows a utilization of method 100 in the validation framework.

Simulation data SD including a number of simulation signals and providing reference data RD including a number of reference signals are multidimensional signals, in particular two- or multidimensional vectors and/or correlated signals and/or time series signals. Two- or multidimensional vectors are used, for example, when a spatial orientation is described. Correlated signals are used, for example, to combine multiple outputs of a model for the purpose of illustrating the correlation of the outputs. In the case of time series signals, each point in time, at which a signal is received, is regarded as an individual signal. A reception of a time series having N points in time is thus illustrated as an N-dimensional signal.

By carrying out method 100, in particular by carrying out a computer program PRG1 on a processing unit 300, the simulation model is validated.

Further specific embodiments relate to a utilization of a computer-implemented method according to the specific embodiments and/or of a computer program according to the specific embodiments for validating a simulation model of a technical system, in particular software, hardware, or an embedded system, in particular during the development of the technical system.

The simulation model is a HiL, hardware in the loop, or a SiL, software in the loop, simulation model. The simulation model is used in this case to imitate the real environment of the technical system. HiL and SiL are methods for testing hardware and embedded systems or software, for example for support during the development as well as premature start-up. By using method 100 for validating a simulation model of a technical system, in particular software, hardware, or an embedded system, in particular during the development of the technical system, a simulation-based approval may be supported, for example. Furthermore, by using method 100 an improved simulation model for the development and/or validation of the technical system, and thus advantageously further positive effects, such as increased security, may be provided.

The technical system is software, hardware or an embedded system, for example. The technical system is in particular a technical system, for example a control unit or a software for a control unit, for a motor vehicle, in particular for an autonomous or semi-autonomous motor vehicle. In particular, this may also be a safety-relevant technical system.

In particular, simulation models in the automotive area often include multidimensional signals. Two- or multidimensional vectors are used, for example, to describe the orientation of a motor vehicle. Furthermore, correlated signals are used when the simulation model has several outputs, such as for example temperature, pressure, and speed, and these signals are generally not independent of one another. Time series signals may incidentally be used when a time-relevant component of the signals is to be taken into consideration.

What is claimed is:

1. A computer-implemented method for validating simulation data of a simulation model of a technical system, the method comprising the following steps:
providing simulation data including a number of simulation signals and providing reference data including a number of reference signals, the simulation signals and the reference signals being multidimensional signals and being at least two-dimensional signals; and
determining a metric between a first probability distribution including the simulation data and a second probability distribution including the reference data by using a 1 Wasserstein metric.

2. The computer-implemented method as recited in claim 1, further comprising:
establishing a cost matrix based on the simulation signals and the reference signals;
deriving an optimal transport plan based on the cost matrix; and
computing costs of the optimal transport plan by using the 1 Wasserstein metric.

3. The computer-implemented method as recited in claim 2, wherein establishing the cost matrix includes computing a distance of a particular simulation signal of the simulation signals to a particular reference signal of the reference signals.

4. The computer-implemented method as recited in claim 3, wherein for computing the distance, a Euclidian distance is used as a distance measure.

5. The computer-implemented method as recited in claim 1, further comprising:
standardizing the simulation data and/or the reference data.

6. The computer-implemented method as recited in claim 1, wherein the multidimensional signals include two- or multidimensional vectors and/or correlated signals and/or time series signals.

7. A non-transitory computer-readable medium on which is stored a computer program for validating data of a simulation model, the computer program, when executed by a computer, causing the computer to perform the following steps:
providing simulation data including a number of simulation signals and providing reference data including a number of reference signals, the simulation signals and the reference signals being multidimensional signals and being at least two-dimensional signals; and
determining a metric between a first probability distribution including the simulation data and a second probability distribution including the reference data by using a 1 Wasserstein metric.

8. The method as recited in claim 1, wherein the simulation model is a simulation model of a technical system, the technical system being software, hardware, or an embedded system, during the development of the technical system.
